(19) United States
(12) Patent Application Publication
(10) Pub. No.: US 2018/0108019 A1
(43) Pub. Date: Apr. 19, 2018

(54) Secure Encryption Using Genomic Information

(71) Applicant: Systems Imagination, Inc., Scottsdale, AZ (US)

(72) Inventors: David Schneider, Scottsdale, AZ (US); Christopher Yoo, Scottsdale, AZ (US)

(21) Appl. No.: 15/783,849

(22) Filed: Oct. 13, 2017

Related U.S. Application Data
(60) Provisional application No. 62/408,742, filed on Oct. 15, 2016.

(51) Int. Cl. G06Q 20/40; G06Q 20/02; G06Q 20/38

(52) U.S. Cl. CPC G06Q 20/40145; C40B 40/08; G06Q 20/3821; G06Q 20/023

(57) ABSTRACT

The invention provides an improved genomics-based method and apparatus for identification, authentication, and verification. Genomic information from an individual's genome, is used as an encryption key in methods, systems and apparatus for transmitting data in an encrypted fashion. The resulting encrypted data set is secure and may be employed in financial, telecommunications, military, and healthcare environments.

### CROSS-REFERENCE TO RELATED APPLICATIONS

This application is related to U.S. Provisional Application No. 62/408,742, filed on Oct. 15, 2016, which is herein incorporated by reference, in its entirety, for all purposes.

### FIELD OF THE INVENTION

The present invention pertains in general to the field of data encryption and decryption using the informational value of a genome. The genome can be that of a human or another organism. More particularly, the invention pertains to securing data transfers over potentially unsecured channels of communication, e.g. electronic transactions. Still more particularly, the invention pertains to practical implementation of data encryption using genetic sequence data information.

### BACKGROUND OF THE INVENTION

An individual's physical makeup is determined by his or her genes. Genes are comprised of DNA, which in turn basically consists of four nucleotides: adenine (A); guanine (G); cytosine (C); and thymine (T). A particular series of these nucleotides is known as a gene sequence. Each gene sequence codes for a protein. Collectively, this DNA constitutes the unique biological “fingerprint” of an individual.

Whole genome sequencing provides the most comprehensive collection of an individual's genetic variation. (Ng, P. C., Kirkness, E. F. (2010). Whole genome sequencing. Methods Mol. Biol. 628, 215-226.) Complete sequencing of the ˜6 Gb of DNA that uniquely identifies each human individual is accomplished through fragmentation of the DNA, sequencing of millions of DNA fragments in lengths of 25-1,000 bases, and the subsequent assembly of these reads into large contiguous segments that can be ordered and oriented along each chromosome. With the development of new sequencing technologies, whole genome sequencing of human populations is increasingly feasible, and is generating terabytes of new individualized data on a daily basis. (Ng, P. C., Kirkness, E. F. (2010). Whole genome sequencing. Methods Mol. Biol. 628, 215-226.)

Simultaneously, transfers of sensitive data over potentially unsecured networks, such as the Internet or cellular telephone networks, are becoming increasingly common. Many such networks must be openly accessible and/or shared and are thereby inherently insecure, leaving transactions conducted through these mediums susceptible to interception.

As a response to the pervasive insecurity inherent in these networks, a variety of data encryption schemes has developed and been implemented. Many data encoding schemes employ a reversible encryption algorithm modeled after the Data Encryption Standard (DES), or alternatively, a combination of public and private keys to encrypt data, such as the Rivest-Shamir-Aldeman (RSA) encryption system used in a multitude of commercial software packages.

There are two key items to consider when exchanging information that one wishes to remain secret from eavesdropping, interception and misuse: (a) Authentication—the process of verifying that the two entities in communication are in fact who they say they are; and (b) Encryption—the process of transmitting the contents of the message such that an entity without the appropriate key can not unlock (read) the message.

Authentication is carried out through a key exchange process. The most common mechanism is a challenge-response mechanism which uses public key cryptographically secure keys through SSH (secure shell). The entities involved in a key exchange use a cryptographically secure operation to digitally sign each key. The most common and accepted form is currently RSA (the initials stand for the first letter of the last name of the three inventors). Other, less recommended mechanisms include DSA, ECDSA, Ed25519 and others.

Biometrics refers to metrics related to human characteristics that are used for authentication. Biometric identifiers are the distinctive, measurable characteristics used to label and describe individuals. The greatest strength of biometrics is at the same time its greatest liability. It is the fact that an individual's biometric data does not change over time: the pattern in your iris, retina or palm vein remain the same throughout your life. Unfortunately, this means that should a set of biometric data be compromised, it is compromised forever. The user only has a limited number of biometric features (one face, two hands, ten fingers, two eyes). For authentication systems based on physical tokens such as keys and badges, a compromised token can be easily canceled and the user can be assigned a new token. Similarly, user IDs and passwords can be changed as often as required. But if the biometric data are compromised, the user may quickly run out of biometric features to be used for authentication. See http://www.biometricnewsportal.com/biometrics_issues.asp accessed Oct. 13, 2016.

Encryption on the other hand, does not authenticate either party but rather encrypts the contents of the message itself. The current most commonly used encryption standard is AES (Advanced Encryption Standard) which was adopted in 2001 as the replacement of DES. AES relies on substitution and permutations that work on blocks of data of a given size (16×16 is the 256 size) for a number of rounds.

Generally encryption based on any mathematical model is subject to any number of particular modes of attack (http://eprint.iacr.org/2009/374, http://cs.tau.ac.i/˜tromer/papers/cache.pdf, https://www.schneier.com/blog/archives/2005/05/aes_timing_atta_1.html) accessed Sep. 23, 2016.

Further, encryption through these models requires specialized software or hardware, increases the size of the message, and therefore increases the power required for every transaction (to process, transmit and store).

The sole form of data encryption that is currently viewed as “unconditionally secure” (i.e., viewed as an unbreakable encoding scheme by cryptographic experts) is the one-time pad (“OTP”), also known as a Vernam cipher, developed by Glibert S. Vernam while employed by AT&T in 1917. Other forms of data encryption may be classified as “cryptographically secure”, meaning that the costs associated with breaking the code by pure mathematical methods and extensive computation are prohibitively high, although the code can theoretically be broken. In contrast, one-time pads are unconditionally secure, and no amount of analysis or computing power will suffice to break the code, because there is no pattern in the data. http://www.tandfonline.com/doi/abs/10.1080/01611194.2011.583711 accessed Sep. 23, 2016. Miller, Frank (1882). Telegraphic code to insure privacy and secrecy in the transmission of telegrams. C. M. Cornwell.

U.S. Pat. No. 1,310,719 discloses the use of encryption based on the use of of a one-time pad. Derived from a Vernam cipher, the system was a cipher that combined a message with a key read from a punched tape. In its original form, Vernam's system was vulnerable because the key tape was a loop, which was reused whenever the loop made a full cycle. One-time use came later, when Joseph Mauborgne recognized that if the key tape were totally random, then cryptanalysis would be impossible (Kahn, David (1996). The Codebreakers. pp. 397-8. ISBN 0-684-83130-9.

U.S. Pat. No. 7,047,222 discloses secure encryption of data packets for transmission over unsecured networks. In this patent pure random numbers from a sheet within a one-time pad are employed to encrypt the bytes of a source data packet and to order the encrypted bytes in a random order within the encrypted data packet. Pure random numbers fill remaining positions within the encrypted data packet. According to the disclosure the resulting encrypted data packet is unconditionally secure (i.e., unbreakable). Sheets within the one-time pad are utilized only once, and the one-time pad is replaced when exhausted. Also disclosed are examples for electronic checking applications, wherein the one-time pad is distributed to the user stored in an electronic checkbook, with a copy retained by the bank. For cellular telephone applications, the one-time pad is stored in a replaceable memory chip within the mobile unit with a copy retained at a single, secured central computer. Also disclosed are examples of client-server applications or applications involving sales over the Internet, wherein the one-time pad may be provided to the user on a floppy disk or CD-ROM, with a copy retained by the vendor. This patent is incorporated herein by reference in its entirety.

As discussed in U.S. Pat. No. 7,047,222, the one time pad is often considered impractical because the security of the system requires that the contents of the one-time pad be known only to the proper encrypting and decrypting entities. This requires secure distribution of the one-time pads. The one-time pad, when properly employed, also requires large amounts of pure random data for the encryption/decryption values which, by definition, may be used only once. Additionally, since the one-time pad contains only a finite number of random numbers for encryption, replacement of the one-time pad is inevitably required. Finally, the one-time pad encryption method is less ideally suited for encryption of long, variable length messages than alternative, less secure encryption schemes. For these reasons, one-time pads have not been employed up to this time in actual encryption systems for commercial applications, such as banking, cellular telephony, etc. Many of these issues are addressed by the unique features of the present invention.

In addition, the security of a OTP makes it extremely desirable. It would be desirable, therefore, to provide methods, systems, and apparatus for employing one-time pads in commercial applications requiring encryption of data for transfer over unsecured networks. It would further be advantageous to provide an implementation of one-time pads which could be readily adapted to a variety of commercial data encryption requirements. The instant invention provides such advantageous methods, systems, and apparatus.

### SUMMARY OF THE INVENTION

Provided herein are methods and an encryption and decryption system comprising two copies of genomic data.

Provided also are methods and systems for securely performing a transaction using genomic data comprising:
a. providing an encryption key comprised of genomic data;
b. providing transaction data;
c. encrypting said transaction data with said genomic data to produce encrypted data;
d. transmitting said encrypted data;
e. decryption of the encrypted data; and
f. completion of the transaction.

### DETAILED DESCRIPTION OF THE PREFERRED EMBODIMENT

It is one object of the present invention to provide an improved method and apparatus for data encryption and decryption.

It is another object of the present invention to provide an improved method and apparatus for securing data transfers over unsecured channels of communication.

It is yet another object of the present invention to provide practical, reliable, replicable, large scale implementation of unbreakable data encryption through use of an individual's genetic information.

It is yet another object of the present invention to provide encrypted information containing an individual's genetic information to be used in medical settings, such as clinical trials, or in order to identify new drug targets and/or candidates.

Problems exist for which the one-time pad employing individualized genetic information according to the present invention provides desirable methods and apparatus for use in commercial applications requiring encryption of data over potentially unsecured networks, and particularly for financial, telecommunications, military, and health-related data where maintenance of security and anonymity is a desired goal. It would further be advantageous to provide an implementation of such genome-based one time pads which would be readily adapted to a variety of commercial data encryption requirements. http://www.cs.utsa.edu/˜wagner/laws/pad.html accessed Sep. 23, 2016.

The use of individual genetic information in conjunction with the security of one-time pads, confers uniquely beneficial applications to the financial, telecommunications, military and healthcare sectors as well. Aside from providing a novel method for the identification and authentication of an individual and transactions, the use of whole-genome sequencing uniquely positions embodiments of the present invention to not only rapidly and accurately identify patients, but could also be used to provide pertinent medical information useful for diagnosis and treatment, such as the initial characterization of genomic traits with implications for future healthcare needs and biomedical assays.

Additional embodiments include military applications. In certain embodiments, the encryption system serves to provide a secure encryption system, preferably absolute, without the need for quantum computing, and at significantly lower power requirements than current systems, for military transactions and communications, including remote and in-field operations, and also including mesh networks and devices.

In certain embodiments of the invention sequences from any of the numerous genome sequences available from a large variety of organisms can be used. See https://en.wikipedia.org/wiki/List_of_sequenced_animal_genomes accessed Oct. 13, 2016.

In whole genome data there are often indeterminate sequences, those that could not be correctly identified as C, G, T, or A. This is a result of the state of the art combined with large size of the genome sequence. Thus the sequence data generally includes not only A, G, C, and T but also contains the additional genomic sequence units (“GSU” s) as defined in Table 1. There are actual 17 GSUs rather than just the 4 representing actual nucleotides. This actually improves the usefulness of the genomic DNA information as a genomic one time pad. Should technology advance to remove such errors however it will not lessen the ability to use the genomic sequence data as an encryption key. The four nucleotides' GSUs are sufficient.

Additionally, the data can be obtained as early or late within the sequencing pipeline as desired. If desired, the data could be obtained from the “FASTQ” data and even interleaved with the quality scores (for example, Phred scores). This would expand the list of units to 94 units and because the quality score values completely overlap (at a value level) with the genomic units (e.g. there are quality scores of A, C, G etc.), it is not possible to predict if the pad value against a message value will be a quality score or genomic score. The width (number of unique values) of the pad units is wider than many language sets. This has the benefit of reducing or eliminating pad bias.

TABLE 1
List of Genomic Sequence Units

| Genomic Sequence Unit identifier | Meaning |
|---|---|
| A | adenosine |
| C | cytidine |
| G | guanine |
| T | thymidine |
| N | A/G/C/T (any) |
| U | uridine |
| K | G/T (keto) |
| S | G/C (strong) |
| Y | T/C (pyrimidine) |
| M | A/C (amino) |
| W | A/T (weak) |
| R | G/A (purine) |
| B | G/T/C |
| D | G/A/T |
| H | A/C/T |
| V | G/C/A |
| — | gap of indeterminate length |

The encryption and decryption with OTP use the same method and apparatus—most often a bitwise operation—that requires only trivial code to implement—and no specific nor specialized hardware. The strength of an OTP is that it “leaks” no information. Trivial demonstrations against an OTP rely on previously existing knowledge (e.g. if you know the message starts with “Hi there” then you can obviously find the pad values—but you already knew the message and because this is an OTP, no information has leaked about the remainder of the pad—none of it is ever re-used. In the present invention whole genome sequence or a portion of it can provide a “finger print” or code that encompasses the entirety or a portion of the human genome that is absolutely unique to an individual, allowing for superior identification, authentication, and encryption methods.

In certain embodiments of the invention, this genome “finger print” or “code” is composed of two (almost) identical data sets of approximately 3,234,830,000 bases per genome. 0.1% of this code is different between any two people. Abecasis et al. (2012) Nature. 491: 56-65.—“An integrated map of genetic variation from 1,092 human genomes” doi:10.1038/nature11632. PMC 3498066. PMID 23128226. While this does not sound like a lot of variation, it is those differences which account for the incredible diversity of humananity. Those 3,234,830 million differences, dispersed throughout the genetic code of an individual, also provide a wonderful source for “one time pads” useful for data encryption according to the present invention.

Variations in the genome include small changes, such as Single-nucleotide polymorphisms (SNPs), but also large changes such as Copy Number Alterations (CNAs), Insertions and Deletions (InDels), Amplifications, and numerous genomic rearrangements as a result of transposable genetic elements and other genomic events inherent to cellular biology. Additionally, changes that occur to regulate the expression of genes (such as DNA methylation) are also uniquely present in individuals, adding to the complexity of gene data. Such infinite combinations of possible variations between individuals is the basis of the unique identifier function in this claim.

SNPs occur normally throughout a person's DNA. They generally occur once in every 300 nucleotides on average, which means there are roughly 10 million SNPs in the human genome. Most commonly, these variations are found in the DNA between genes but SNPs do not occur homogeneously across the human genome. In fact, there is enormous diversity in SNP frequency between genes, reflecting different selective pressures on each gene as well as different mutation and recombination rates across the genome.

The specific variations (SNPs, CNAs, etc.) are not the only variability. Even within intra-chromosomal regions, the ‘regular’ patterns are highly polymorphic and are interspersed with a variety of non-regular patterns, sub-patterns and etc.—none of which are aligned the same from person to person. The key here is that if the ‘average’ person has the following sequence at position 1,000,000:

(SEQ ID NO: 1)
g c g c t t a g g g g c

The sequence represents 12 positions and, in theory, with 17 element values, this represents 17¹²=582 trillion possible combinations for this sequence.

For demonstration, if it is assumed that an individual can only have this sequence—and that every individual has this sequence with only 2 variable values and shifted to the left or right by up to 2 positions, then for this sequence, we have over 100,000 possible sequence patterns. Thus, even regions with a high homology have enough variance across individuals to prevent a very complex brute force attack across even trivial portions of the “code book” or OTP.

To decode a portion of a message with brute force (as in the example above), all 582 trillion combinations must be generated, run EACH against the message and then take the results to determine which ones are probabilistically most likely (e.g. make sense given the context of the communication).

For communications about transactions, there is no mechanism which will predict if a given transaction id/sku or the like is more likely than any other combination, thus making the probabilistic measure at the end of the 582 trillion checks useless. This is for a sequence of only 17 characters and so in whole genome embodiments of the invention the situation is much more complex and secure.

The minimal width of the potential pad (17 values) minimizes pad value bias for transactions since they are unlikely to use more than 26 values. The maximal pad width completely eliminates pad bias.

While, in certain embodiments, the whole genome itself could be used as an encryption key, and that is certainly encompassed by the present invention, the whole code does not have to be used. Instead, in some embodiments, the 3 billion base code can serve as the source of an almost unlimited number of unique one time pads or encryption keys. Each person would then have a one-time pad “code book”.

In one embodiment of the invention a person provides an institution with a defined portion of her genetic code that starts at a defined position. For example, she could provide 1,000,000 base pairs starting at position 1,000,000,000 (her one time pad book). If the institution generally has transactions with the person involving 100 units of data then the encryption key could also be 100 units. Thus the small part of her genome comprising her OTP could be used for more than 10,000 unique pads/keys. More particularly, her institution would know that the first transaction key would start at a pre-defined point in the 1,000,000 base pairs and could, for example, continue along the sequence linearly, providing a unique key for each transaction. Only the institution would know what transaction number they are on and in what position they are on the sequence.

Thus, the small part of her genome (of 1,000,000 base pairs) could be used for more than 10,000 distinct unique transactions with that institution.

Each such transaction would be smaller than any encrypted transaction using current technologies, work faster, and require less power to process, transmit and store.

OTP transactions require a trivial mechanism to implement (generic pseudocode: Unicode(msgi)̂Unicode(padj.i)->char) accessed Sep. 23, 2016.

Embodiments of this invention reduce the complexity of everything from cards to card readers to POS systems and onward, and eliminate the possibility of stealing card/transaction information as has happened to high profile retailers recently. The present invention eliminates this possibility because, while the thieves would still have THAT transactions data, they would have no way of determining the next transaction pad since that information is simply not used for the given transaction—it is only used on the next transaction. There is again no leak of information.

Storage of information that is padded according to the invention is not only smaller than typical encryption schemes, reducing hard drive storage requirements, power requirements etc, but it can be trivially compressed, thus actually reducing the storage and energy costs further.

In one embodiment, the transaction data is stored in Unicode. See https://en.wikipedia.org/wiki/Unicode accessed Sep. 2, 2016. The genetic sequence unit code representations of the genome are also stored in or converted into Unicode. The two data streams can be “added” or transformed using an operation such as XOR or another bitwise or modular reversible operation to generate a unique, unbreakable, Unicode string that can only be deciphered using the “key.” In example of this, a bitwise XOR takes two bit patterns of equal length and performs the logical exclusive OR operation on each pair of corresponding bits. The result in each position is 1 if only the first bit is 1 or only the second bit is 1, but will be 0 if both are 0 or both are 1. In this we perform the comparison of two bits, being 1 if the two bits are different, and 0 if they are the same. See https://en.wikipedia.org/wiki/Bitwise_operation accessed Sep. 2, 2016.

For more information on XOR cryptography see for example: http://xrds.acm.org/blog/2012/08/unbreakable-cryptography-in-5-minutes/ accessed Sep. 23, 2016.

While an XOR operation is vulnerable to a known-plaintext attack, such an operation is not useful against a one-time pad attack. For example, if our message is “Walmart: Store xxxx mm-dd-yyyy . . . ” and the attacker knows that the start of the message is always “Walmart: Store xxxx”, then the attacker can reverse the XOR and discover that portion of the key. This is not a useful attack against the instant invention since the information gained (the key portion relating to “Walmart.”) is used only once, and reveals only what the attacker already knew—e.g. “Walmart: Store xxxx”.

Further, a known-plaintext attack as a vector will not reveal what the person purchased—and this is important—even if every single item the given retailer sells at that location on that day is known. Here is why:

Any reversible classical operation can be used: XOR, −/+fixed quantity, multiply by odd integer (force ‘even’ calculated key bytes to be odd), rotate/shift by x-bits defined by the key, interleaving, and other similar operations.

In certain embodiments, the space required is dependent on the size of the space to be encoded. In some embodiments a 32-bit representation will suffice for most embodiments, and specifically for financial, identification, and image embodiments. A particular embodiment may use any operation which fits within the encoded space. Thus, if an embodiment involves encoding a dataspace with a width of 32 bits, with a requirement to maintain an encoded space of 32-bits, then XOR and rotations are usable while interleaving is not (since it requires additional space), but if the embodiment can have an encoded space of 64 bits, then any 32-bit reversible operation could be used.

While many embodiments outlined herein involve bitwise XOR operations any reversible classical operation is usable in certain embodiments.

According to the invention, and through the use of the one time pad system and methods according to the invention, it is equally likely that any of the possible products sold (any SKU or product description) in any combination for the remainder of the message are generated. This is because simply substituting in a new pattern of the possible key will generate an output. You can generate every possible SKU by walking through n-number of keys. There will be no cases of duplication (of the SKU) and therefore statistically there is no weight or distribution to the output. There are, helpfully, millions of combinations that are statistically unlikely genetically (e.g. a key of kkkwwuuuuu) that will produce no valuable output—but while that helps the attacker know that you aren't an alien—it does not provide any output resulting in viable answers.

In one embodiment, a user initiates a transaction at a retail outlet. Her card contains her OTP book sequence code as well as the transaction number and the last position in the code that was used. The retail machine reads the card and obtains the appropriate length and position key, performs the XOR operation and transmits the encrypted data to the institution. The institution has the previous transactions stored and so knows that it is performing a particular transaction number, at a particular sequence position and so is able to convert the encrypted data back into the original transaction data using its stored OTP book.

In certain embodiments of the invention, a clearing house may be utilized. A clearing house is a financial institution that provides clearing and settlement services for financial and commodities derivatives and securities transactions.

In another embodiment, the entire calculation process is handled by the customer, for example on her smart phone, or smart card. In this embodiment, the retail machine provides the transaction data to the customer smart phone, the customer's smart phone uses its stored code (OTP) to encrypt the data and provides the encrypted data back to the retail machine which transmits the data to the bank for approval.

In another embodiment, the institution could be given, for example, 1,000,000,000 base pairs of genomic data starting at a defined position. If they ever felt that their data had become insecure they could merely move the starting position of the 1,000,000 base pair OTP “book”. Thus instantly achieving complete encryption again. The only way to know what sequences they were using would be to know where they had begun.

Genomic data solves many of the existing problems with one time pads: the contents of the one-time pad can easily be distributed to a limited set of entities for encrypting and decrypting. The one-time pad, when properly employed, also requires large amounts of pure random data for the encryption/decryption values which, by definition, may be used only once. Genomic data provides a large amount of unique, effectively random data. Since each one-time pad contains only a finite number of random numbers for encryption, replacement of the one-time pad is required. Genomic data provides an ideal solution and method of replacing the one time pads. Finally, previous the one-time pad encryption method is less ideally suited for encryption of long, variable length messages than alternative, less secure encryption schemes. Using genomic data stored electronically solves this problem for one time pads as this data is ideally suited of encryption of long, variable length messages.

One major advantage of this invention is that ultimately the encryption key can be reproduced by re-sequencing the subject's DNA (or indeed merely the part in question). For example, if a subject claims that she did not initiate the transaction a new DNA sample can be obtained from the person and the encryption key can be matched to the person's DNA.

Certain embodiments of the present invention represent improvements over U.S. Pat. No. 7,047,222 which discloses secure encryption of data packets for transmission over unsecured networks. In this patent, pure random numbers from a sheet within a one-time pad are employed to encrypt the bytes of a source data packet and to order the encrypted bytes in a random order within the encrypted data packet. Pure random numbers fill remaining positions within the encrypted data packet. According to the disclosure the resulting encrypted data packet is unconditionally secure (i.e., unbreakable). Sheets within the one-time pad are utilized only once, and the one-time pad is replaced when exhausted. Also disclosed are examples for electronic checking applications, wherein the one-time pad is distributed to the user stored in an electronic checkbook, with a copy retained by the bank. For cellular telephone applications, the one-time pad is stored in a replaceable memory chip within the mobile unit with a copy retained at a single, secured central computer. Also disclosed are examples of client-server applications or applications involving sales over the Internet, wherein the one-time pad may be provided to the user, with a copy retained by the vendor. This patent is incorporated herein by reference in its entirety.

Medical applications could employ the use of clinic registration in order to validate a sponsored clinic/clinician and address associated security issues in that context. Users interested in adopting this service could integrate their systems with the user cloud-database for retrieval of one-time pad sequences.

Additional security measures could employ the use of facial recognition prior to decryption of one-time pad sequences, resulting in the requirements of a registered picture, device with biometric, and 3-billion character sequence as the replacements for the conventional passport and/or driver's license. Ostensibly, the present invention has the capacity to address identification concerns over a host of various institutions, such as banking, local and federal governments, social media, and healthcare.

In the foregoing specification, the invention has been described with a specific embodiment thereof. However, it will be evident to the skilled artisan that various modifications and changes may be made thereto without departing from the broader spirit and scope of the invention.

Moreover, the invention is not limited to the specific applications described. The system and method of the invention have many other application.

Therefore, the scope of the invention should be determined by the appended claims and their legal equivalents.

We claim:

1. An encryption system comprising two copies of genomic data.

2. A method for securely performing a transaction comprising:
a. providing an encryption key comprised of genomic data;
b. providing transaction data;
c. encrypting said transaction data with said genomic data to produce encrypted data;
d. transmitting said encrypted data;
e. decryption of the encrypted data; and
f. completion of the transaction.

3. The method according to claim 2 wherein the decryption is performed using knowledge of the encryption key acquired through knowledge of previous transactions and the genomic data.

4. The method of claim 3 wherein the decryption step comprises deriving the encryption key by starting at a sequence position in the genomic data following the last sequence position used for a previous transaction.

5. The method according to claim 2 wherein the encrypted data is transmitted to a third party for decryption.

6. The method according to claim 5 wherein the third party is a financial institution, clearing house, or health care institution.

7. The method according to claim 5 wherein the third party decrypts the data using a copy of the genomic data.

8. The method according to claim 2 wherein the genomic data and the transaction data are stored as Unicode data.

9. The method according to claim 8 wherein the data is subjected to a bitwise reversible set of operations.

10. The method according to claim 9 wherein the bitwise reversible set of operations is XOR.

11. The encryption system according to claim 1 wherein a first copy of the genomic data is a portable copy of the genomic data while a second copy of the genomic data is stored at a location whose role comprises decrypting encrypted data.

12. The encryption system according to claim 1 wherein at least one of the copies of genomic data is less than the whole genome sequence of a subject.

13. A method of processing an electronic payment transaction, comprising:
a. receiving an electronic payment transaction encrypted using a genomic one-time pad at a business;
b. transmitting an encrypted first copy of said electronic payment transaction to a payor's financial institution and an encrypted second copy of said electronic payment transaction to a payee's financial institution;
c. decoding said encrypted first copy of said electronic payment transaction at said payor's financial institution using a copy of said genomic one-time pad;
d. authenticating said electronic payment transaction;
e. transmitting said encrypted first copy of said electronic payment transaction over an unsecure communication link to a clearinghouse with a payment authorization;
f. transmitting said encrypted second copy of said electronic payment transaction over an unsecure communication link to said clearinghouse;
g. comparing, at said clearinghouse, said encrypted first copy of said electronic payment transaction that has been transmitted over an unsecure communication link to said encrypted second copy of said electronic payment transaction that has been transmitted over an unsecure communication link; and
h. responsive to determining that said encrypted first copy of said electronic payment transaction matches said encrypted second copy of said electronic payment transaction and that the payment authorization has been received, processing, at said clearinghouse, a transaction transferring funds from said payor's financial institution to said payee's financial institution.

14. The method according to claim 13 wherein the electronic payment transaction is an electronic check, a debit card transaction, a wire transfer, a credit card transaction, a smart phone financial transaction, a gift card transaction, a loan payment, or a direct withdrawal.

15. The system according to claim 1 which further comprises a decryption system.
